(19) United States
(12) Patent Application Publication
(10) Pub. No.: US 2020/0004178 A1
(43) Pub. Date: Jan. 2, 2020

(54) IMAGE FORMING APPARATUS

(71) Applicant: CANON KABUSHIKI KAISHA, Tokyo (JP)

(72) Inventor: Naoyuki Yamamoto, Nagareyama-shi (JP)

(21) Appl. No.: 16/450,711

(22) Filed: Jun. 24, 2019

(30) Foreign Application Priority Data
Jun. 28, 2018 (JP) 2018-123762

(51) Int. Cl. G03G 15/10; G03G 21/00; G03G 21/20; G03G 15/11

(52) U.S. Cl. CPC G03G 15/105; G03G 15/11; G03G 21/203; G03G 21/0088

(57) ABSTRACT

An image forming apparatus includes a movable image bearing member on which an image is formed with use of a liquid developer including toner and a carrier liquid in an image forming position, a transfer unit configured to transfer the image from the image bearing member to a recording material in a transfer position, an acquisition unit configured to acquire information about a moisture content of the recording material, an adjustment unit configured to be able to supply a carrier liquid to the image bearing member on a downstream side of the image forming position and on an upstream side of the transfer position with respect to a movement direction of the image bearing member, and a control unit configured to cause the adjustment unit to adjust a quantity of the carrier liquid which is conveyed to the transfer position according to the moisture content of the recording material.

### BACKGROUND OF THE INVENTION

### Field of the Invention

Aspects of the present invention generally relate to an image forming apparatus using the electrophotographic system or electrostatic recording system, and, more particularly, relate to an image forming apparatus which operates with use of a liquid developer in which toner particles are dispersed in a carrier liquid.

### Description of the Related Art

Heretofore, there has been known an image forming apparatus which forms a toner image on an image bearing member with use of a liquid developer including toner particles (toner) and liquid carriers (carrier liquid) and transfers the formed toner image to a recording material, such as a sheet of recording paper (sheet). In such an image forming apparatus which operates with use of a liquid developer, it is known that the proportion of toner included in the liquid developer has a great effect on image quality. Furthermore, the proportion of toner included in the liquid developer is referred to as “T/D”, and is expressed in percentage by mass standard.

Usually, the viscosity of a liquid developer increases in conjunction with the T/D, and the migration speed of toner in the liquid developer obtained during application of a bias is greatly affected by the influence of viscous resistance. Therefore, the migration speed of toner in a liquid developer with a high T/D obtained during application of a bias becomes lower than the migration speed of toner in a liquid developer with a low T/D under the influence of viscous resistance. Accordingly, a liquid developer with a high T/D has the possibility of causing a problem such as a density reduction due to insufficient migration of toner. On the other hand, a liquid developer with a low T/D has the possibility of causing an image defect such as toner image deletion due to a positional deviation of toner which is caused by toner being pulled by the flow of the liquid developer.

On the other hand, when a toner image formed with a liquid developer is transferred to a recording material, a carrier liquid included in the toner image permeates the recording material. Therefore, the T/D of the toner image varies, so that an image defect may occur. For example, in the case of a recording material which allows a high rate of permeation of a carrier liquid, some toner may not be completely transferred to the recording material due to a decrease in toner migration amount caused by an increase in T/D, so that a reduction in transfer efficiency or missing transfer may occur. Conversely, in the case of a recording material which allows only a low rate of permeation of a carrier liquid or which does not allow permeation of a carrier liquid, a surplus carrier liquid remains on the recording material while maintaining a low value of T/D, so that a disturbance of an image caused by toner image deletion may occur. In this way, since the most appropriate T/D for transfer differs depending on types of recording materials, it is desirable to optimize the liquid quantity of a carrier liquid in a transfer portion for every type of recording material.

Japanese Patent Application Laid-Open No. 2003-91161 discusses an image forming apparatus which operates with use of a liquid developer, the image forming apparatus including a unit configured to adjust the T/D and allowing adjusting the amount of removal of a surplus carrier liquid in such a way as not to disturb a toner image formed on an image bearing member. In such an image forming apparatus, it is possible to appropriately regulate the film thickness of a liquid developer adhering to the surface of a photosensitive drum by adjusting the contact pressure of a sweep roller which is able to contact the photosensitive drum, thus adjusting the amount of removal of a surplus carrier liquid.

However, the rate of permeation of a carrier liquid into a recording material varies depending on not only types of recording materials but also a moisture content (percentage of moisture content) contained in a recording material. Specifically, when the moisture content of a recording material is large, the interval between paper fibers increases, so that the rate of permeation of a carrier liquid into the recording material by capillary action becomes low. Conversely, when the moisture content of a recording material is small, the interval between paper fibers decreases, so that the rate of permeation of a carrier liquid becomes high. Furthermore, the moisture content of a recording material depends on the temperature and humidity of an environment in which the recording material is manufactured and packaged, the temperature and humidity of an environment in which the recording material is stored, and the temperature and humidity of an environment in which the recording material is used. In other words, just adjusting the liquid quantity of a carrier liquid of the toner image according to the type of a recording material as in the image forming apparatus discussed in Japanese Patent Application Laid-Open No. 2003-91161 is not enough, and, in particular, when a recording material which has been stored in a high-humidity environment or low-humidity environment is used, the most appropriate T/D may not be able to be obtained.

### SUMMARY OF THE INVENTION

Aspects of the present invention are generally directed to providing an image forming apparatus which is capable of preventing or reducing the excess or deficiency of a carrier liquid in a transfer portion according to the moisture content of a recording material.

According to an aspect of the present invention, an image forming apparatus includes a movable image bearing member on which an image is formed with use of a liquid developer including toner and a carrier liquid in an image forming position, a transfer device configured to transfer the image from the image bearing member to a recording material in a transfer position, an acquisition unit configured to acquire information about a moisture content of the recording material, a supply device configured to be able to supply a carrier liquid to the image bearing member on a downstream side of the image forming position and on an upstream side of the transfer position with respect to a movement direction of the image bearing member, and a control unit configured to cause the supply device to operate in such a manner that a quantity of the carrier liquid which is conveyed to the transfer position per unit area for unit time is a first amount in a case where the moisture content of the recording material indicated by the information acquired by the acquisition unit is a first moisture content, and the quantity of the carrier liquid which is conveyed to the transfer position per unit area for unit time is a second amount larger than the first amount in a case where the moisture content of the recording material indicated by the information acquired by the acquisition unit is a second moisture content which is smaller than the first moisture content.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of a station.

FIG. 3 is an outline block diagram illustrating a control aspect of essential portions of the image forming apparatus.

FIGS. 4A and 4B are a schematic sectional view of a carrier liquid adjustment device and a schematic diagram illustrating a drive configuration and a switching mechanism, respectively.

FIGS. 5A, 5B, and 5C are schematic sectional views used to explain operation modes of the carrier liquid adjustment device.

FIG. 6 is a graph chart illustrating a relationship between the T/D obtained immediately before secondary transfer and secondary transfer efficiency in plain paper.

FIGS. 7A and 7B are a graph chart illustrating a relationship between the T/D obtained immediately before secondary transfer and secondary transfer efficiency in coated paper and a table illustrating a relationship between the T/D obtained immediately before secondary transfer and an image defect in coated paper, respectively.

FIG. 8 is a flowchart illustrating a setting procedure for operation modes of the carrier liquid adjustment device.

FIG. 9 is a schematic sectional view used to explain another example of an adjustment unit.

FIGS. 10A, 10B, and 10C are schematic sectional views used to explain a yet another example of an adjustment unit.

FIG. 11 is a schematic block diagram used to explain another example of an acquisition unit.

### DESCRIPTION OF THE EMBODIMENTS

Various exemplary embodiments, features, and aspects of an image forming apparatus according to the invention will be described in detail below with reference to the drawings.

### <1. Overall Configuration and Operation of Image Forming Apparatus>

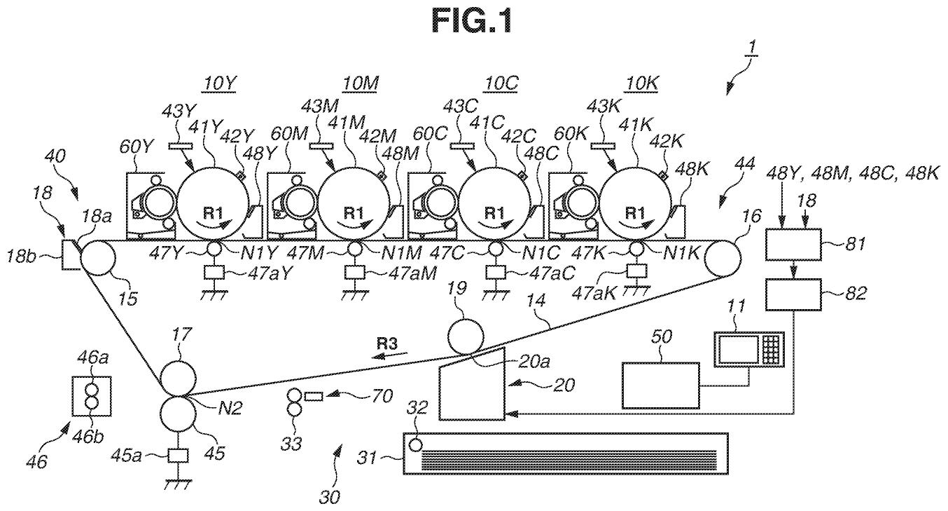

FIG. 1 is a schematic sectional view of an image forming apparatus 1 according to an exemplary embodiment of the invention. The image forming apparatus 1 in the present exemplary embodiment is a digital printer of the electrophotographic system which forms, on a recording material, an image which is formed with use of a liquid developer including toner and a carrier liquid. Furthermore, herein, upward and downward directions regarding the image forming apparatus 1 or elements thereof refer to the vertical direction in the direction of gravitational force, but do not mean only the direct upward direction and direct downward direction and also include an upper side and lower side with respect to a horizontal plane passing through a critical or reference element or position.

As illustrated in FIG. 1, the image forming apparatus 1 includes a sheet feeding unit 30, an image forming unit 40, a carrier liquid adjustment device 20, a control unit 50, and an operation unit 11. Furthermore, a sheet S, which serves as a sheet-shaped recording material, is used to form a toner image thereon, and, specifically, includes, for example, plain paper, coated paper with a coat agent applied to the surface thereof, thick paper, overhead projector transparent (OHT) sheet, and resin film. The image forming apparatus 1 operates based on an image signal and outputs an image by transferring a toner image formed by the image forming unit 40 to the sheet S, which is sequentially conveyed from the sheet feeding unit 30, and then fixing the toner image to the sheet S. The image signal is transmitted from, for example, an external terminal apparatus (not illustrated), such as a scanner (image reading apparatus) or a personal computer, to the image forming apparatus 1.

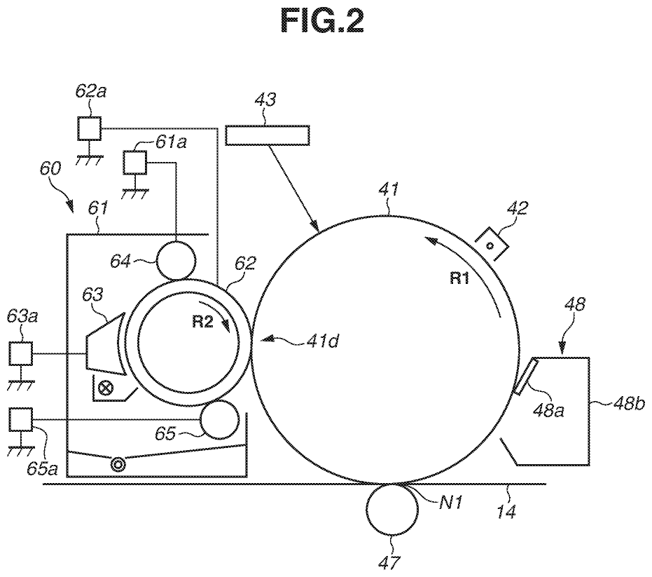

The image forming unit 40 includes first, second, third, and fourth stations 10Y, 10M, 10C, and 10K, which serve as a plurality of toner image forming units, an intermediate transfer belt 14, which is suspended in a tensioned manner by a plurality of tensile suspension rollers, a secondary transfer outer roller 45, and a fixing device 46. The image forming unit 40 is able to form an image on the sheet S based on image information. Furthermore, the image forming apparatus 1 in the present exemplary embodiment is compliant with full-color image formation, and the first, second, third, and fourth stations 10Y, 10M, 10C, and 10K are configured to form toner images of yellow (Y), magenta (M), cyan (C), and black (K), respectively. In the present exemplary embodiment, the configurations and operations of the first, second, third, and fourth stations 10Y, 10M, 10C, and 10K are substantially the same except for colors of toners to be used. Accordingly, respective elements having identical or corresponding functions or configurations in the first, second, third, and fourth stations 10Y, 10M, 10C, and 10K may be collectively described with suffixes Y, M, C, and K of the reference characters, which indicate for which color each element is used, omitted. In the present exemplary embodiment, the station 10 is configured to include, for example, a photosensitive drum 41, a charger 42, an exposure device 43, a development device 60, a primary transfer roller 47, and a drum cleaning device 48, which are described below. FIG. 2 is a schematic sectional view illustrating one station 10 as a representative in more detail.

The photosensitive drum 41, which is a rotatable (movable) drum-shaped photosensitive member (electrophotographic photosensitive drum) serving as a first image bearing member, is driven to rotate in the direction of arrow R1 in FIG. 2 by a drum driving motor (not illustrated) serving as a drive unit. The photosensitive drum 41 rotates (performs circling movement) while bearing an electrostatic image (electrostatic latent image) formed based on image information during image formation. Moreover, the photosensitive drum 41 rotates while bearing a toner image formed by an electrostatic image being developed with use of a liquid developer in a development portion 41d, which is a contact portion between a developing roller 62 described below and the photosensitive drum 41.

The charger 42, which serves as a charging unit, is located approximately in parallel with the rotation center axis of the photosensitive drum 41 and opposite to the photosensitive drum 41 and is configured to electrically charge the surface of the photosensitive drum 41 uniformly to a dark portion potential Vd of the same polarity as that of electric charge of toner at a charging position. In the present exemplary embodiment, since toner in use is negatively chargeable toner, the dark portion potential Vd takes a negative value. Moreover, in the present exemplary embodiment, a corona charger is used as the charger 42. However, the charging unit is not limited to a corona charger, but can be another type of charging unit, such as a charging roller.

The exposure device 43, which serves as an exposure unit, radiates laser light to the surface of the photosensitive drum 41 electrically charged to the dark portion potential Vd, at an exposure position on the downstream side of the charging position for the charger 42 with respect to the rotation direction (the direction of arrow R1) of the photosensitive drum 41. The exposure device 43 performs exposure on the surface of the photosensitive drum 41, thus causing a potential drop in the exposure portion on the surface of the photosensitive drum 41 and then forming an electrostatic image on the surface of the photosensitive drum 41. The potential of the exposure portion at which a potential drop has been caused by irradiation of the surface of the photosensitive drum 41 with laser light is referred to as a light portion potential Vl. Furthermore, the exposure unit is not limited to exposure using laser light, but can be another type of exposure unit, such as a light-emitting diode (LED).

The development device 60, which serves as a development unit, includes a development container 61, a developing roller 62, a development electrode 63, a squeeze roller 64, and a cleaning roller 65. The development container 61 contains the developing roller 62, the development electrode 63, the squeeze roller 64, and the cleaning roller 65, and receives a liquid developer which is supplied from a mixer serving as a mixing unit (not illustrated) by a supply device serving as a supply unit (not illustrated). The development device 60 is located in such a manner that the developing roller 62 is in contact with the photosensitive drum 41 in the development portion (development position) 41d on the downstream side of the exposure position used for the exposure device 43 with respect to the rotation direction (the direction of arrow R1) of the photosensitive drum 41.

In the present exemplary embodiment, the developer which is used by the development device 60 is a liquid developer in which toner is dispersed in a carrier liquid. Toner includes a coloring agent and a binding agent as primary components and is negatively chargeable resin particles of 0.1 μm to 2.0 μm in average particle diameter with, for example, a charging aid added thereto. Thus, in the present exemplary embodiment, the normal charging polarity (charging polarity during development) of toner is a negative polarity. The carrier liquid is a non-volatile liquid with high resistivity and low-dielectric constant, and the volume resistivity thereof is 1.0×10¹⁰ (Ω·m) or more, the relative permittivity thereof is 10 or less, and the viscosity thereof is 1 to 100 (mmPa·s). The carrier liquid usable in the present exemplary embodiment includes, for example, an insulating carrier liquid, such as silicone oil, mineral oil, or Isopar M® (manufactured by Exxon Mobile), with, for example, a charging control agent added thereto. Moreover, the carrier liquid usable in the present exemplary embodiment can include a liquid monomer having a photo-curing ability as long as it satisfies the above-mentioned physical property values. In the present exemplary embodiment, the T/D (the proportion of toner included in the liquid developer: the percentage by mass standard) of a liquid developer which is supplied to the development device 60 is adjusted to be 1% to 15%. Furthermore, while a liquid developer the viscosity of which exceeds 100 (mmPa·s) is usable in principle, since a burden of liquid conveyance increases, in the present exemplary embodiment, a liquid developer with a relatively low viscosity is used and, in a concentration process described below, the viscosity of the liquid developer is heightened together with the T/D.

The developing roller 62, which serves as a developer bearing member (developing member), includes a rotation shaft made from metal and an elastic layer formed from conductive rubber serving as an elastic material around the rotation shaft. The developing roller 62 is in contact with the photosensitive drum 41, and, at a contact region thereof, the developing roller 62 comes into contact with the photosensitive drum 41 at a predetermined pressure, so that a development portion 41d is formed. The developing roller 62 receives a predetermined developing bias which is applied by a development power source (high-voltage power source circuit) 62a. The developing roller 62 is driven to rotate by a development driving motor (not illustrated) serving as a drive unit in the direction of arrow R2 in FIG. 2 (the direction to move in the direction associated with the rotation direction of the photosensitive drum 41 at the contact portion with the photosensitive drum 41) in such a manner that the surface velocity of the developing roller 62 becomes approximately equal to the surface velocity of the photosensitive drum 41. The developing roller 62 is able to supply a liquid developer to the photosensitive drum 41, thus developing an electrostatic image on the surface of the photosensitive drum 41 with toner at the development portion 41d. Furthermore, a liquid developer the T/D of which has been previously adjusted by the mixer is supplied to a clearance between the developing roller 62 and the development electrode 63. Then, according to the rotation of the developing roller 62, a liquid developer present near the surface of the developing roller 62 is conveyed while being borne on the surface of the developing roller 62.

The development electrode 63 is located opposite to the developing roller 62. A bias of the same polarity as that of toner is applied to the developing roller 62 by a supply power source (high-voltage power source circuit) 63a through the development electrode 63. According to the rotation of the developing roller 62, the liquid developer borne on the developing roller 62 passes through a clearance between the development electrode 63 and the developing roller 62. At this time, according to application of the bias to the development electrode 63, toner included in the liquid developer present in the clearance between the development electrode 63 and the developing roller 62 is electrophoresed toward the surface of the developing roller 62. According to the rotation of the developing roller 62, the liquid developer which has passed through the clearance between the development electrode 63 and the developing roller 62 is conveyed to a contact region between the developing roller 62 and the squeeze roller 64, which is on the downstream side of that clearance with respect to the rotation direction of the developing roller 62 (the direction of arrow R2). Furthermore, adjusting the magnitude of the bias to be applied to a clearance between the development electrode 63 and the developing roller 62 enables adjusting the T/D of the liquid developer in the development portion 41d, and further enables adjusting the T/D of the liquid developer in a secondary transfer portion N2 described below.

The squeeze roller 64, which serves as a regulation member, is pressed against the developing roller 62 by a pressure unit (not illustrated), and is driven to rotate in conjunction with the rotation of the developing roller 62. Moreover, a bias of the same polarity as that of toner is applied to the developing roller 62 by a regulation power source (high-voltage power source circuit) 61a through the squeeze roller 64. This causes the liquid developer on the surface of the developing roller 62 to be regulated to be approximately uniform in film thickness (thickness), and also causes the T/D to rise to 25% to 40%, so that the liquid developer is concentrated (concentration process). Here, the film thickness of a carrier liquid which passes through between the developing roller 62 and the squeeze roller 64 is determined based on a pressure applied between the developing roller 62 and the squeeze roller 64, the Young's modulus of the developing roller 62, the viscosity of the liquid developer, and the process speed. Accordingly, adjusting a pressure force for pressing the squeeze roller 64 to the developing roller 62 enables adjusting the film thickness of the liquid developer which arrives at the development portion 41d. Furthermore, the application amount of toner is able to be adjusted by the magnitude of a bias which is applied between the development electrode 63 and the developing roller 62.

A liquid developer which has not been able to pass through between the developing roller 62 and the squeeze roller 64 and has been thrusted back passes through a portion above the development electrode 63 and is then returned to the mixer by a discharge device serving as a discharge unit (not illustrated). Thus, the squeeze roller 64 is able to decrease the liquid quantity of a carrier liquid adhering to the developing roller 62.

The liquid developer which has been concentrated through the concentration process is supplied to an electrostatic image on the photosensitive drum 41 according to the rotation of the developing roller 62, so that the electrostatic image is developed as a toner image. At this time, the T/D of an image portion of the toner image on the photosensitive drum 41 increases as compared with the T/D of the liquid developer obtained immediately after the concentration process, and is thus 30% to 45%. This is because, while, to develop an image portion on the photosensitive drum 41, a major portion of toner and a part of carrier liquid on the developing roller 62 move to the photosensitive drum 41, a given quantity of carrier liquid remains on the developing roller 62. Furthermore, similar phenomena can also occur in a primary transfer process, a secondary transfer process, and a T/D adjustment process, which are described below.

The cleaning roller 65, which serves as a developing member cleaning unit, is located on the downstream side of the development portion 41d with respect to the rotation direction of the developing roller 62 (the direction of arrow R2). The cleaning roller 65 is provided in such a way as to be pressed against the developing roller 62 by a pressure unit (not illustrated). Moreover, a bias of the polarity opposite to that of toner is applied to the developing roller 62 by a cleaning power source (high-voltage power source circuit) 65a through the cleaning roller 65. This causes a liquid developer which has remained on the surface of the developing roller 62 after development to be removed. The liquid developer which has been removed from the surface of the developing roller 62 is returned to the mixer by the discharge unit.

The drum cleaning device 48, which serves as a photosensitive member cleaning unit, includes a cleaning blade 48a, which serves as a cleaning member, and a recovery container 48b. The drum cleaning device 48 is located in such a manner that the cleaning blade 48a is in contact with the photosensitive drum 41 in a cleaning position which is on the downstream side of a primary transfer portion N1 described below with respect to the rotation direction of the photosensitive drum 41 (the direction of arrow R1). In the drum cleaning device 48, a liquid developer which has remained on the surface of the photosensitive drum 41 after primary transfer is scraped off by the cleaning blade 48a to be removed from the surface of the photosensitive drum 41 and is then recovered into the recovery container 48b. The liquid developer which has been removed from the surface of the photosensitive drum 41 and then recovered into the recovery container 48b is conveyed to a separation device 81 serving as a separation unit by a conveyance device serving as a conveyance unit (not illustrated). The separation device 81 separates the conveyed liquid developer into a carrier liquid and a high-concentration liquid developer. Then, the carrier liquid which has been obtained by separation performed by the separation device 81 is conveyed to a reuse carrier tank 82 serving as a carrier liquid container portion, and the high-concentration liquid developer is conveyed to a waste liquid tank (not illustrated).

An intermediate transfer belt 14, which is an intermediate transfer member configured with a rotatable (movable) endless belt, serving as an image bearing member, is located in such a way as to face four photosensitive drums 41. The intermediate transfer belt 14 is wound around a driving roller 15, a tension roller 16, and a secondary transfer inner roller 17, which serve as a plurality of tensile suspension rollers, to be suspended in a tensioned manner with a predetermined tensile force. The intermediate transfer belt 14 is rotated (revolved) in the direction of arrow R3 in FIG. 1 by the driving roller 15 being driven to rotate by a belt driving motor (not illustrated) serving as a drive unit. The primary transfer roller 47, which is a roller-type primary transfer member serving as a primary transfer unit, is located on the inner circumferential surface side of the intermediate transfer belt 14 in such a way as to face each photosensitive drum 41. The primary transfer roller 47 is urged toward the photosensitive drum 41 by a pressure unit (not illustrated) in such a way as to pinch the intermediate transfer belt 14, thus forming a primary transfer portion (primary transfer nip) N1, in which the photosensitive drum 41 and the intermediate transfer belt 14 are in contact with each other. An intermediate transfer unit 44 is configured to include, for example, the intermediate transfer belt 14, the tensile suspension rollers 15 to 17 therefor, and the respective primary transfer rollers 47.

In the present exemplary embodiment, the intermediate transfer belt 14 is configured with an electric resistance adjusting agent, such as carbon black, added thereto, and the volume resistivity thereof is set to 1.0×10⁹ to 1.0×10¹³ (Ω·cm). The intermediate transfer belt 14 has a predetermined or more tensile force applied thereto even when not being driven. Moreover, in the present exemplary embodiment, the intermediate transfer belt 14 is always in contact with four photosensitive drums 41 without being away therefrom. A primary transfer bias of the positive polarity, which is a polarity opposite to that of toner, is applied to the primary transfer roller 47 by a primary transfer power source (high-voltage power source circuit) 47a. This causes a toner image configured with toner of the negative polarity on the photosensitive drum 41 to be transferred (primarily transferred) onto the intermediate transfer belt 14 in the primary transfer portion N1. With this, the intermediate transfer belt 14 bears a toner image, which has been formed by developing an electrostatic image on the surface of the photosensitive drum 41, and moves. The T/D of an image portion of the toner image transferred onto the intermediate transfer belt 14 further increases as compared with the T/D of an image portion of the toner image formed on the photosensitive drum 41, thus becoming 35% to 50%.

The secondary transfer outer roller 45, which is a roller-type secondary transfer member serving as a secondary transfer unit, is located at a position facing the secondary transfer inner roller 17 on the outer circumferential surface side of the intermediate transfer belt 14. The secondary transfer outer roller 45 is urged toward the secondary transfer inner roller 17 by a pressure unit (not illustrated) in such a way as to pinch the intermediate transfer belt 14, thus forming a secondary transfer portion (secondary transfer nip) N2, in which the intermediate transfer belt 14 and the secondary transfer outer roller 45 are in contact with each other. Thus, the secondary transfer portion N2 is formed by the secondary transfer inner roller 17 and the secondary transfer outer roller 45, which are in contact with each other via the intermediate transfer belt 14. A sheet S is conveyed to the secondary transfer portion N2 by the sheet feeding unit 30. The sheet S conveyed to the secondary transfer portion N2 is then conveyed while being pinched between the secondary transfer outer roller 45 and the intermediate transfer belt 14. A secondary transfer bias of the positive polarity, which is a polarity opposite to that of toner, is applied to the secondary transfer outer roller 45 by a secondary transfer power source (high-voltage power source circuit) 45a. This causes a toner image configured with toner of the negative polarity on the intermediate transfer belt 14 to be transferred (secondarily transferred) onto the sheet S in the secondary transfer portion N2. In the present exemplary embodiment, the secondary transfer inner roller 17 is electrically grounded (connected to ground). Furthermore, the secondary transfer outer roller 45 can be configured to be electrically grounded and a bias of the polarity opposite to that of the bias to be applied to the secondary transfer outer roller 45 in the present exemplary embodiment can be configured to be applied to the secondary transfer inner roller 17.

The sheet feeding unit 30 includes a sheet cassette 31, which serves as a recording material container portion that contains sheets S of, for example, recording paper (recording sheets), a feeding roller 32, which serves as a conveyance member, and a registration roller 33, which serves as a timing control member. A sheet S contained in the sheet cassette 31 is fed toward the image forming unit 40 by the feeding roller 32. The feeding roller 32 rotates in parallel with a toner image forming operation and separates and feeds the uppermost sheet S contained in the sheet cassette 31. The sheet S as conveyed is once stopped by the registration roller 33, the rotation of which is at a stop. Then, the sheet S is timed to coincide with a toner image on the intermediate transfer belt 14 and conveyed to the secondary transfer portion N2 by the registration roller 33.

A belt cleaning device 18, which serves as an intermediate transfer member cleaning unit, is located on the downstream side of the secondary transfer portion N2 and on the upstream side of the primary transfer portion N1 (the most upstream primary transfer portion N1Y) with respect to the rotation direction of the intermediate transfer belt 14 (the direction of arrow R3). In the present exemplary embodiment, the belt cleaning device 18 is located at a position facing the driving roller 15 on the outer circumferential surface side of the intermediate transfer belt 14. The belt cleaning device 18 includes a cleaning blade 18a, which serves as a cleaning member, and a recovery container 18b. In the belt cleaning device 18, a liquid developer which has remained on the surface of the intermediate transfer belt 14 after secondary transfer is scraped off by the cleaning blade 18a to be removed from the surface of the intermediate transfer belt 14 and is then recovered into the recovery container 18b. The liquid developer which has been removed from the surface of the intermediate transfer belt 14 and then recovered into the recovery container 18b is conveyed to the separation device 81 by a conveyance unit. The separation device 81 separates the conveyed liquid developer into a carrier liquid and a high-concentration liquid developer as mentioned above, conveys the carrier liquid to the reuse carrier tank 82, and conveys the high-concentration liquid developer to a waste liquid tank (not illustrated).

The fixing device 46, which serves as a fixing unit, includes a fixing roller 46a, which is equipped with a heating source, and a pressure roller 46b, which is in pressure contact with the fixing roller 46a. The sheet S with a toner image transferred thereto in the secondary transfer portion N2 is conveyed while being pinched between the fixing roller 46a and the pressure roller 46b. With this, an unfixed toner image on the sheet S is heated and pressed to be fixed (fused and firmly fixed) to the surface of the sheet S. Furthermore, the fixing unit is not limited to the one using heating and pressure, but can be another type of fixing unit, such as the one using light irradiation if the liquid developer is of a photo-curable type, such as an ultraviolet curable type.

An image forming operation in the image forming apparatus 1 configured as described above is further described with the case of full-color image formation taken as an example. When a print job start signal is input to the control unit 50, an image forming operation is started, so that the rotation of, for example, each photosensitive drum 41 and the intermediate transfer belt 14 is started. The surface of the photosensitive drum 41 rotating is uniformly subjected to electric charging processing by the charger 42. Then, exposure is performed in a scanning manner by the exposure device 43 on the surface of the photosensitive drum 41 subjected to electric charging processing based on image information for a color corresponding to the associated station 10, so that an electrostatic image is formed on the photosensitive drum 41. The electrostatic image formed on the photosensitive drum 41 is developed (made visible) by the development device 60 with use of a liquid developer, so that a toner image is formed on the photosensitive drum 41. Toner images of respective colors, yellow, magenta, cyan, and black, formed on the respective photosensitive drums 41 are sequentially transferred (primarily transferred) onto the intermediate transfer belt 14 in a superposed manner at the respective primary transfer portions N1. The toner images transferred onto the intermediate transfer belt 14 in a multiple manner are collectively transferred (secondarily transferred) onto the sheet S at the secondary transfer portion N2. The sheet S with the toner image transferred thereto is conveyed to the fixing device 46, and, after the toner image is fixed to the sheet S by the fixing device 46, the sheet S is discharged (output) to the outside of the apparatus body of the image forming apparatus 1. Moreover, the photosensitive drum 41 subjected to primary transfer processing is cleaned by the drum cleaning device 48, and the intermediate transfer belt 14 subjected to secondary transfer processing is cleaned by the belt cleaning device 18.

Here, in the present exemplary embodiment, the toner image transferred onto the intermediate transfer belt 14 at the primary transfer portion N1 is conveyed to the secondary transfer portion N2 via a T/D adjustment portion (T/D adjustment position) 20a formed by the carrier liquid adjustment device 20, which is described below. Thus, the T/D adjustment portion 20a formed by the carrier liquid adjustment device 20 is located on the downstream side of the primary transfer portion N1 (the most downstream primary transfer portion N1K) and on the upstream side of the secondary transfer portion N2 with respect to the rotation direction of the intermediate transfer belt 14 (the direction of arrow R3). In other words, the carrier liquid adjustment device 20 is located in such a way as to be able to act on a conveyance path for the liquid developer by the intermediate transfer belt 14 from the primary transfer portion N1 (the most downstream primary transfer portion N1K) to the secondary transfer portion N2. Furthermore, the carrier liquid adjustment device 20 is described below in detail.

Moreover, the image forming apparatus 1 in the present exemplary embodiment includes a moisture content sensor 70, which serves as a moisture content detection unit configured to detect a moisture content (percentage of moisture content) contained the sheet S. In the present exemplary embodiment, the moisture content sensor 70 is located in such a way as to be able to detect the moisture content of the sheet S at a detection position on the downstream side of the sheet cassette 31 and on the upstream side of the registration roller 33 with respect to the conveyance direction of the sheet S. In particular, in the present exemplary embodiment, the moisture content sensor 70 detects the moisture content of the sheet S when the sheet S is once stopped at the registration roller 33. Examples of the moisture content sensor 70 to be used include a microwave sensor and a near-infrared sensor. Moreover, electrodes can be used to measure the electrical resistance or electrostatic capacitance of the sheet S to estimate the moisture content. In the present exemplary embodiment, the moisture content sensor 70 irradiates the sheet S with light (electromagnetic waves), such as infrared rays or microwaves of a specific wavelength and detects the amount of reflection or the amount of transmission of the light, thus detecting the amount of light absorption occurring in the sheet S. Typically, the amount of light absorption occurring in the sheet S is larger (the amount of reflection or amount of transmission of light is smaller) when the moisture content of the sheet S is a second moisture content larger than a first moisture content than when the moisture content of the sheet S is the first moisture content. Information about the amount of light absorption occurring in the sheet S detected by the moisture content sensor 70 is input to the control unit 50. In the present exemplary embodiment, the moisture content sensor 70 constitutes an acquisition unit configured to acquire information about the moisture content of the sheet S by irradiating the sheet S with light (electromagnetic waves) at the detection position and detecting a reflection characteristic or transmission characteristic of the light. In the present exemplary embodiment, as described below in detail, one of operation modes of the carrier liquid adjustment device 20 is selected based on a result of detection of the moisture content of the sheet S by the moisture content sensor 70.

### <2. Control Aspect>

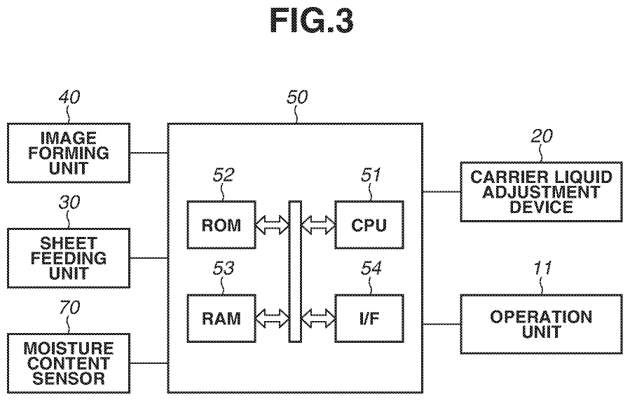

FIG. 3 is an outline block diagram illustrating an outline control aspect of essential portions of the image forming apparatus 1 in the present exemplary embodiment. The image forming apparatus 1 includes the control unit 50, which serves as a control unit configured to comprehensively control various units of the image forming apparatus 1. The control unit 50, which is configured with a computer, includes a central processing unit (CPU) 51, a read-only memory (ROM) 52, which stores programs, a random access memory (RAM) 53, which temporarily stores data about, for example, computation results or detection results, and an input-output circuit (interface (I/F)) 54, which inputs and outputs signals with respect to external devices. The control unit 50 is connected to, for example, the operation unit 11, the carrier liquid adjustment device 20, the sheet feeding unit 30, the image forming unit 40, an image reading device (not illustrated), and the moisture content sensor 70 via the input-output circuit 54, and is configured to exchange signals with those units and control operations of those units. Moreover, the control unit 50 is configured to be able to connect to an external terminal apparatus (not illustrated), such as a personal computer, via the input-output circuit 54.

The operation unit 11 is an operation panel including, for example, operation buttons, which serve as an input unit configured to input, for example, various settings to the control unit 50, and a display portion, which serves as a display unit configured to display various pieces of information to an operator, such as the user or the service representative, according to control performed by the control unit 50. The operation unit 11 is able to set, for example, in addition to types of sheets S, the number of copies, enlargement, reduction, density, double-sided printing or single-sided printing, color or monochrome, a cassette to be used for sheet feeding, and sheet sizes with respect to the control unit 50 according to an operation performed by the operator. Furthermore, similar settings are also configured to be able to be performed via an external terminal apparatus such as a personal computer. Here, the types of sheets (recording materials) S include generally-characterized attributes, such as plain paper, thick paper, thin paper, glossy paper, coated paper, and embossed paper, and any given pieces of information usable to distinguish sheets S, such as manufacturer, brand, part number, grammage, thickness, and size. In the present exemplary embodiment, the types of sheets S which are settable for selection are assumed to include at least plain paper and coated paper, which a carrier liquid is less likely to permeate than plain paper.

### <3. Configuration of Carrier Liquid Adjustment Device>

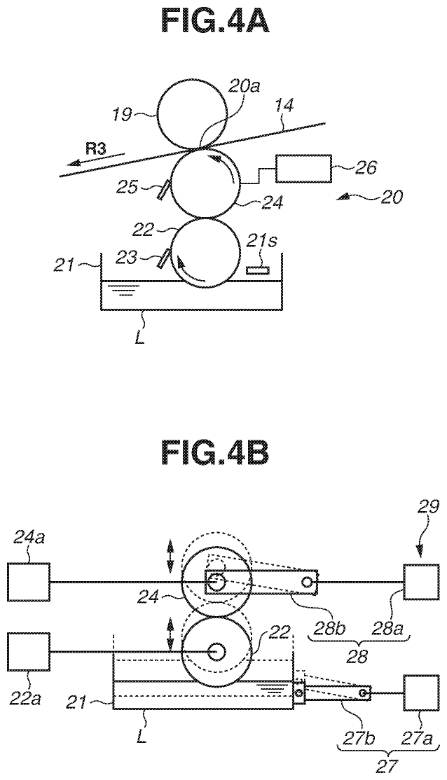

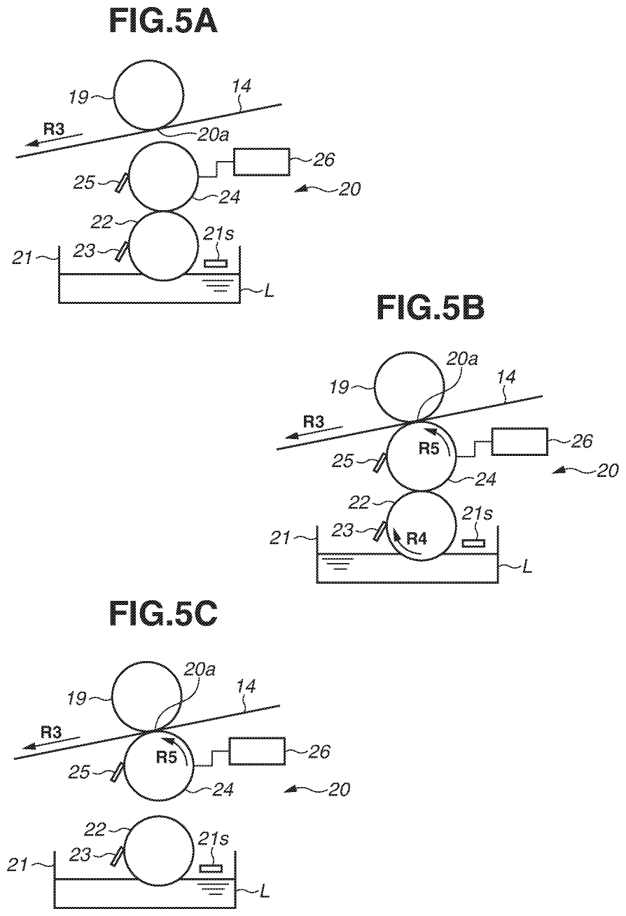

Next, the carrier liquid adjustment device 20, which serves as an adjustment unit, in the present exemplary embodiment is described. FIG. 4A is a schematic sectional view of the carrier liquid adjustment device 20, illustrating a cross-section approximately perpendicular to the rotation axis line direction of each tensile suspension roller for the intermediate transfer belt 14. FIG. 4B is a schematic diagram illustrating outline configurations of a driving mechanism for the carrier liquid adjustment device 20 and a switching mechanism therefor described below. Moreover, FIGS. 5A, 5B, and 5C are schematic sectional views illustrating a plurality of different operation modes of the carrier liquid adjustment device 20 described below.

The carrier liquid adjustment device 20 is provided at a position which faces the intermediate transfer belt 14 on the downstream side of the primary transfer portion N1 (the most downstream primary transfer portion N1K) and on the upstream side of the secondary transfer portion N2 with respect to the rotation direction of the intermediate transfer belt 14 (the direction of arrow R3). An adjustment portion counter roller 19, which serves as an adjustment portion counter member, is located at a position facing the carrier liquid adjustment device 20 on the inner circumferential surface side of the intermediate transfer belt 14. The inner circumferential surface of the intermediate transfer belt 14 is supported by the adjustment portion counter roller 19. The adjustment portion counter roller 19 is driven to rotate in conjunction with the rotation of the intermediate transfer belt 14. In the present exemplary embodiment, the adjustment portion counter roller 19 is configured with an elastic roller including a core metal (base material) and a conductive elastic layer formed therearound, and the core metal is electrically grounded. The adjustment portion counter roller 19 can be regarded as serving as one of a plurality of tensile suspension rollers for the intermediate transfer belt 14 or can be regarded as serving as a part of the carrier liquid adjustment device 20. In the carrier liquid adjustment device 20, an adjustment roller 24 described below coming into contact with the adjustment portion counter roller 19 via the intermediate transfer belt 14 forms a T/D adjustment portion (T/D adjustment position) 20a, in which the intermediate transfer belt 14 and the adjustment roller 24 are in contact with each other. Furthermore, any tensile suspension roller which is located on the downstream side of the primary transfer portion N1 (the most downstream primary transfer portion N1K) and on the upstream side of the secondary transfer portion N2 can be used as an adjustment portion counter roller. In the present exemplary embodiment, the carrier liquid adjustment device 20 is located below the surface (outer circumferential surface) of the intermediate transfer belt 14.

The carrier liquid adjustment device 20 includes a carrier liquid tank 21, a supply roller 22, a supply roller regulating blade 23, an adjustment roller 24, an adjustment roller regulating blade 25, an adjustment power source (high-voltage power source circuit) 26, and a liquid level sensor 21s. Moreover, the carrier liquid adjustment device 20 further includes a switching mechanism 29 (FIG. 4B), serving as a switching unit, which includes a supply roller raising and lowering device 27 and an adjustment roller raising and lowering device 28.

The carrier liquid tank 21 is a liquid storage tank which is open upward, and is situated below the supply roller 22 and the adjustment roller 24, and a carrier liquid L is stored inside the carrier liquid tank 21. The carrier liquid tank 21 is connected to the reuse carrier tank 82, and a carrier liquid L is supplied from the reuse carrier tank 82 to the carrier liquid tank 21 as needed. The liquid level sensor 21s, which serves as a storage amount detection unit, is provided above the liquid level of the carrier liquid L stored in the carrier liquid tank 21. The liquid level sensor 21s is connected to the control unit 50. The control unit 50 controls supplying of the carrier liquid L from the reuse carrier tank 82 to the carrier liquid tank 21 in such a manner that the height of the liquid level of the carrier liquid L in the carrier liquid tank 21 falls within a predetermined range, based on a result of detection by the liquid level sensor 21s. In the present exemplary embodiment, an ultrasonic type sensor is used as the liquid level sensor 21s. The liquid level sensor 21s detects the height of the liquid level of the carrier liquid L by radiating ultrasonic waves toward the liquid level of the carrier liquid L in the carrier liquid tank 21 and detecting a reflection time of the radiated ultrasonic waves. However, the storage amount detection unit is not limited to such an ultrasonic type sensor, but can be any type of storage amount detection unit capable of detecting the storage amount of the carrier liquid L in the carrier liquid tank 21.

The supply roller 22, which serves as a supply member, is located above the carrier liquid tank 21 and below the adjustment roller 24. The supply roller 22 is configured to be able to be driven to rotate in the direction of arrow R4 illustrated in FIG. 5B (the direction to move in the same direction with respect to the adjustment roller 24 at a contact portion with the adjustment roller 24) by a supply roller driving motor 22a (FIG. 4B), serving as a drive unit. The supply roller 22 lies between the carrier liquid L stored in the carrier liquid tank 21 and the adjustment roller 24. Moreover, the supply roller 22 is configured to be able to be raised and lowered along the vertical direction together with the carrier liquid tank 21 by the supply roller raising and lowering device 27, serving as a supply roller movement unit. The supply roller raising and lowering device 27 is configured to include a raising and lowering driving unit (for example, a motor) 27a, and a raising and lowering action unit 27b, which transmits a driving force of the raising and lowering driving unit 27a to raise and lower the supply roller 22 together with the carrier liquid tank 21. For details, according to operation modes described below, the supply roller raising and lowering device 27 switches contact and separation states between the supply roller 22 and at least one of the adjustment roller 24 and the carrier liquid L in the carrier liquid tank 21 (in the present exemplary embodiment, the adjustment roller 24). The supply roller 22 is configured to be able to relatively change to the following states (positions). First, in a “contact state” (FIGS. 5A and 5B), the supply roller 22 comes into contact with both the carrier liquid L in the carrier liquid tank 21 and the adjustment roller 24 at the same time. Moreover, in a “separation state” (FIG. 5C), the supply roller 22 separates from at least one of the adjustment roller 24 and the carrier liquid L in the carrier liquid tank 21 (in the present exemplary embodiment, the adjustment roller 24). In the present exemplary embodiment, the supply roller 22 is supported to be able to rotate at relatively the same position with respect to the carrier liquid tank 21 in such a manner that the supply roller 22 is always in contact with the carrier liquid L stored in the carrier liquid tank 21. The supply roller raising and lowering device 27 is connected to the control unit 50. As described below in detail, the control unit 50 controls raising and lowering operations for the supply roller 22 by the supply roller raising and lowering device 27 based on, for example, a result of detection by the moisture content sensor 70, thus switching operation modes of the carrier liquid adjustment device 20.

In the present exemplary embodiment, the supply roller 22 includes a core metal (base material) and an elastic layer formed therearound. In the present exemplary embodiment, the elastic layer is formed from urethane rubber serving as an elastic material. Moreover, in the present exemplary embodiment, the elastic layer is configured to have a volume resistivity of 1.0×10¹¹ (Ω·cm) or more, a JIS-A hardness of 30 to 50 (degrees), and a surface roughness Rz of 2 (μm) or less. Furthermore, the material of the elastic layer is not limited to the above-mentioned one, but can be other than the above-mentioned material, for example, in a case where there are no concerns about swelling caused by the carrier liquid L, variation of the above-mentioned physical property value, variation of the physical property value of the carrier liquid L, and other types of deterioration.

The supply roller regulating blade 23, which serves as a supply roller regulating member, is supported with the relative position thereof fixed to the supply roller 22 in such a manner that the supply roller regulating blade 23 is in contact with the surface of the supply roller 22 at a predetermined contact pressure. The supply roller regulating blade 23 is in contact with the supply roller 22 on the downstream side of a contact portion between the supply roller 22 and the carrier liquid L in the carrier liquid tank 21 and on the upstream side of a contact portion between the supply roller 22 and the adjustment roller 24 with respect to the rotation direction of the supply roller 22 (the direction of arrow R4). This causes the film thickness of the carrier liquid L on the supply roller 22 to be uniformly regulated to be a predetermined value, and causes a surplus carrier liquid L to drop into the carrier liquid tank 21.

In the present exemplary embodiment, the contact pressure of the supply roller regulating blade 23 with respect to the supply roller 22 is set in such a manner that the film thickness of the carrier liquid L on the supply roller 22 obtained after being regulated by the supply roller regulating blade 23 becomes 6 to 20 (μm). Moreover, in a case where the supply roller 22 is set to the “contact state” (FIGS. 5A and 5B), about half of the carrier liquid L on the supply roller 22 transfers from the supply roller 22 to the adjustment roller 24 at a nip formed between the supply roller 22 and the adjustment roller 24. This causes the film thickness of the carrier liquid L on the adjustment roller 24 to become 3 to 10 (μm).

Furthermore, while, in the present exemplary embodiment, a unit configured to control the film thickness of the carrier liquid L which is supplied to the adjustment roller 24 includes the supply roller 22 and the supply roller regulating blade 23, the present exemplary embodiment is not limited to this. A unit configured to control the film thickness of the carrier liquid L on the adjustment roller 24 can include, for example, a roller pair or an anilox roller if it is capable of controlling the film thickness of the carrier liquid L in a sufficiently uniform manner.

The adjustment roller 24, which serves as an adjustment member, is situated above the supply roller 22. The adjustment roller 24 is configured to be able to be driven to rotate in the direction of arrow R5 illustrated in FIG. 5B (the direction to move in the same direction with respect to the intermediate transfer belt 14 at a contact portion with the intermediate transfer belt 14) by an adjustment roller driving motor 24a (FIG. 4B), serving as a drive unit. Moreover, the adjustment power source 26 is connected to the adjustment roller 24. A bias of the negative polarity, which is the same polarity as that of toner, is able to be applied to the adjustment roller 24 by the adjustment power source 26. Moreover, the adjustment roller 24 is configured to be able to be raised and lowered along the vertical direction by the adjustment roller raising and lowering device 28 serving as an adjustment roller movement unit. The adjustment roller raising and lowering device 28 is configured to include a raising and lowering driving unit (for example, a motor) 28a, and a raising and lowering action unit 28b, which transmits a driving force of the raising and lowering driving unit 28a to raise and lower the adjustment roller 24. For details, according to operation modes described below, the adjustment roller raising and lowering device 28 switches contact and separation states between the adjustment roller 24 and the intermediate transfer belt 14. The adjustment roller 24 is configured to be able to relatively change to the following states (positions). First, in a “contact state” (FIGS. 5B and 5C), the adjustment roller 24 comes into contact with the intermediate transfer belt 14. Moreover, in a “separation state” (FIG. 5A), the adjustment roller 24 separates from the intermediate transfer belt 14. With this, switching to the state of performing a supply (addition or application) operation for the carrier liquid L onto the intermediate transfer belt 14 (in more detail, a toner image on the intermediate transfer belt 14), the state of, conversely, performing a removal operation for the carrier liquid L, or the state of performing neither of them is performed. Thus, the adjustment roller 24 is not only able to come into contact with a conveyance path for a liquid developer but also able to bear a carrier liquid L stored in the carrier liquid tank 21. The adjustment roller raising and lowering device 28 is connected to the control unit 50. As described below in detail, the control unit 50 controls raising and lowering operations for the adjustment roller 24 by the adjustment roller raising and lowering device 28 based on, for example, a result of detection by the moisture content sensor 70, thus switching operation modes of the carrier liquid adjustment device 20.

In the present exemplary embodiment, the adjustment roller 24 is configured with a metallic roller formed from a stainless steel (SUS) alloy as a metallic material. In the present exemplary embodiment, the adjustment roller 24 is set to have a surface roughness Rz of 0.2 to 2.0 (μm).

The adjustment roller regulating blade (removal blade) 25, which serves as an adjustment roller regulating member (removal member), is supported with the relative position thereof fixed to the adjustment roller 24 in such a manner that the adjustment roller regulating blade 25 is in contact with the surface of the adjustment roller 24 at a predetermined contact pressure. The adjustment roller regulating blade 25 is in contact with the adjustment roller 24 on the downstream side of a contact portion between the adjustment roller 24 and the intermediate transfer belt 14 and on the upstream side of a contact portion between the adjustment roller 24 and the supply roller 22 with respect to the rotation direction of the adjustment roller 24 (the direction of arrow R5). This causes a carrier liquid L which has remained on the surface of the adjustment roller 24 to be removed, and the removed carrier liquid L drops into the carrier liquid tank 21.

### <4. Operation Modes of Carrier Liquid Adjustment Device>

Next, operation modes of the carrier liquid adjustment device 20 in the present exemplary embodiment are described.

As illustrated in FIGS. 5A to 5C, the carrier liquid adjustment device 20 is able to switch between three operation modes, i.e., “normal mode” (FIG. 5A), “carrier supply mode” (FIG. 5B), and “carrier removal mode” (FIG. 5C). Furthermore, in the “normal mode” illustrated in FIG. 5A, in response to an operation of the above-mentioned switching mechanism 29, the supply roller 22 is situated at a first position, which is on the lower side, and the adjustment roller 24 is situated at a third position, which is on the lower side. Moreover, in the “carrier supply mode” illustrated in FIG. 5B, in response to an operation of the above-mentioned switching mechanism 29, the supply roller 22 is situated at a second position, which is on the upper side, and the adjustment roller 24 is situated at a fourth position, which is on the upper side. In the “carrier removal mode” illustrated in FIG. 5C, in response to an operation of the above-mentioned switching mechanism 29, the supply roller 22 is situated at the first position, which is on the lower side, and the adjustment roller 24 is situated at the fourth position, which is on the upper side.

As illustrated in FIG. 5A, in the “normal mode (first mode)”, the adjustment roller 24 is away from the intermediate transfer belt 14, so that neither the supply of a carrier liquid L to the intermediate transfer belt 14 nor the removal of a carrier liquid L from the intermediate transfer belt 14 is performed. Thus, in a conveyance path for a liquid developer from the development portion 41d to the secondary transfer portion N2, the carrier liquid adjustment device 20 is able to cause the liquid quantity of the carrier liquid L of the liquid developer which is conveyed not to substantially increase and decrease. Therefore, the T/D in the image portion of a toner image on the intermediate transfer belt 14 obtained after the toner image passes through the T/D adjustment portion 20a and before the toner image arrives at the secondary transfer portion N2 (immediately before secondary transfer) remains almost unchanged from that obtained immediately after the primary transfer process, as being 35% to 50%. In the “normal mode”, the supply roller 22 and the adjustment roller 24 are not driven to rotate, so that the application of a bias to the adjustment roller 24 is not performed.

As illustrated in FIG. 5B, in the “carrier supply mode (second mode)”, the adjustment roller 24 is concurrently in contact with the intermediate transfer belt 14 and the supply roller 22, and the supply roller 22 is concurrently in contact with the adjustment roller 24 and the carrier liquid L. A carrier liquid L drawn from the carrier liquid tank 21 by the supply roller 22 is supplied to the adjustment roller 24, and is then supplied from the adjustment roller 24 to the intermediate transfer belt 14. At this time, according to a bias of the same polarity as that of toner applied to the adjustment roller 24, toner on the intermediate transfer belt 14 is not moved to the adjustment roller 24 and remains borne on the intermediate transfer belt 14, so that only the carrier liquid L is increased. Thus, in a conveyance path for a liquid developer from the development portion 41d to the secondary transfer portion N2, the carrier liquid adjustment device 20 is able to increase the liquid quantity of the carrier liquid L of the liquid developer which is conveyed. Therefore, the T/D in the image portion of a toner image on the intermediate transfer belt 14 obtained after the toner image passes through the T/D adjustment portion 20a and before the toner image arrives at the secondary transfer portion N2 (immediately before secondary transfer) decreases as compared with that obtained immediately after the primary transfer process, thus becoming 20% to 35%. A carrier liquid L which has remained on the surface of the adjustment roller 24 after the carrier liquid L is supplied to the intermediate transfer belt 14 is removed by the adjustment roller regulating blade 25, and the removed carrier liquid L drops into the carrier liquid tank 21. In the “carrier supply mode”, the supply roller 22 and the adjustment roller 24 are driven to rotate, and a bias is applied to the adjustment roller 24.

As illustrated in FIG. 5C, in the “carrier removal mode (third mode)”, the adjustment roller 24 is in contact with the intermediate transfer belt 14, and is away from the supply roller 22. In a nip formed by the adjustment roller 24 and the intermediate transfer belt 14, a part of the carrier liquid L on the intermediate transfer belt 14 transfers from the intermediate transfer belt 14 to the adjustment roller 24. At this time, according to a bias of the same polarity as that of toner applied to the adjustment roller 24, toner on the intermediate transfer belt 14 is not moved to the adjustment roller 24 and remains borne on the intermediate transfer belt 14, so that only the carrier liquid L is decreased. Thus, in a conveyance path for a liquid developer from the development portion 41d to the secondary transfer portion N2, the carrier liquid adjustment device 20 is able to decrease the liquid quantity of the carrier liquid L of the liquid developer which is conveyed. Therefore, the T/D in the image portion of a toner image on the intermediate transfer belt 14 obtained after the toner image passes through the T/D adjustment portion 20a and before the toner image arrives at the secondary transfer portion N2 (immediately before secondary transfer) increases as compared with that obtained immediately after the primary transfer process, thus becoming 45% to 60%. A carrier liquid L which has remained on the surface of the adjustment roller 24 after the carrier liquid L is removed from the intermediate transfer belt 14 is removed by the adjustment roller regulating blade 25, and the removed carrier liquid L drops into the carrier liquid tank 21. In the “carrier removal mode”, the supply roller 22 is not driven to rotate, the adjustment roller 24 is driven to rotate, and a bias is applied to the adjustment roller 24.

### <5. Adjustment Method for T/D>

Next, an adjustment method (control method) for the T/D of the image portion of a toner image on the intermediate transfer belt 14 obtained immediately before secondary transfer (herein also referred to simply as “T/D obtained immediately before secondary transfer”), which is based on a result of detection by the moisture content sensor 70, is described.

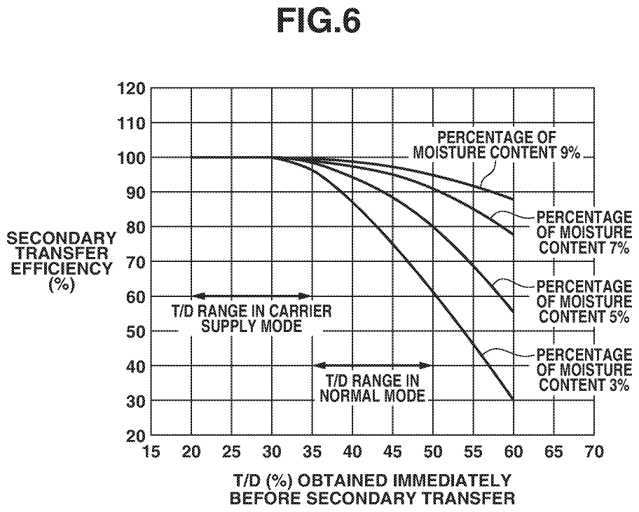

FIG. 6 illustrates a relationship between the T/D obtained immediately before secondary transfer and the secondary transfer efficiency obtained with use of plain paper as the sheet S in a case where the image forming apparatus 1 is caused to operate in the “normal mode” (FIG. 5A). Paper with a product name of “GF-0081” (grammage: 81 g/m²) manufactured by Canon Inc. is used as plain paper.

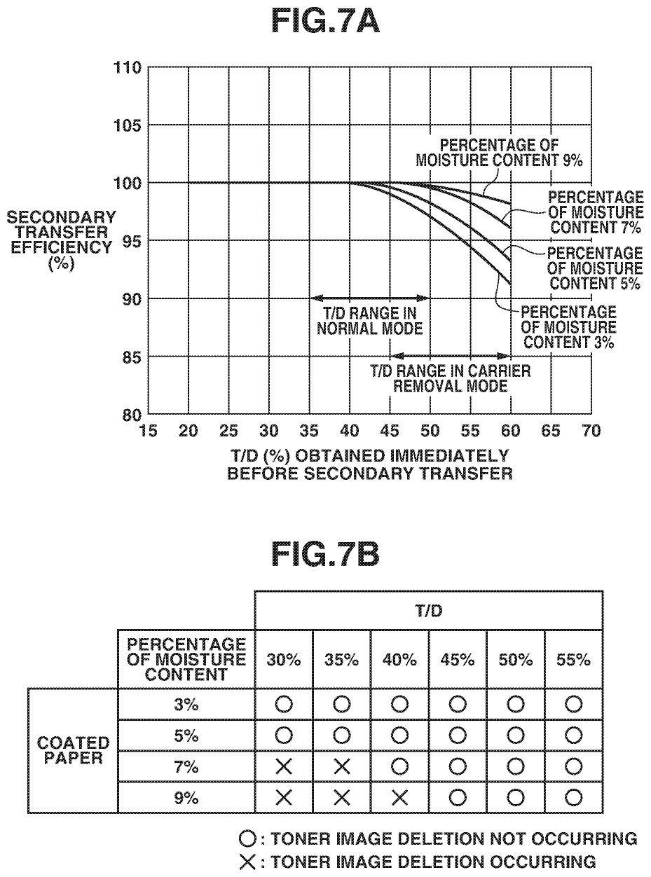

Moreover, FIG. 7A illustrates a relationship between the T/D obtained immediately before secondary transfer and the secondary transfer efficiency obtained with use of coated paper as the sheet S in a case where the image forming apparatus 1 is caused to operate in the “normal mode” (FIG. 5A). Paper with a product name of “OK Topcoat Plus” (grammage: 84.9 g/m²) manufactured by Oji Paper Co., Ltd. is used as coated paper.

Here, the secondary transfer efficiency means the proportion of toner which has moved to the sheet S during secondary transfer to toner present on the intermediate transfer belt 14 immediately before secondary transfer (herein expressed in percentage by mass standard). Thus, in a case where all of the toner present on the intermediate transfer belt 14 immediately before secondary transfer has been transferred to the sheet S, the secondary transfer efficiency is 100%. Moreover, in order that the sheet S had a desired moisture content (percentage of moisture content), a sheet which was left under a predetermined constant temperature and constant humidity environment for 48 hours or more was used as the sheet S.

As illustrated in FIG. 6, in the case of plain paper, when a comparison is made using the same T/D obtained immediately before secondary transfer, plain paper with a smaller moisture content is lower in secondary transfer efficiency than plain paper with a larger moisture content. In the image forming apparatus 1 in the present exemplary embodiment, the T/D obtained immediately before secondary transfer in a case where adjustment of the T/D is not performed by the carrier liquid adjustment device 20 (in the case of the “normal mode”) is 35% to 50%. As illustrated in FIG. 6, in the range in which the T/D obtained immediately before secondary transfer was 35% to 50%, in the case of plain paper with a moisture content of 7% or more, a good secondary transfer efficiency of 90% or more was obtained. On the other hand, in the case of plain paper with a moisture content of 5%, when the T/D obtained immediately before secondary transfer exceeded 43%, the secondary transfer efficiency decreased to less than 90%, so that a reduction of image density and an image loss caused by missing transfer were observed on the sheet S. Moreover, in the case of plain paper with a moisture content of 3%, when the T/D obtained immediately before secondary transfer exceeded 37%, the secondary transfer efficiency decreased to less than 90%, so that a reduction of image density and an image loss caused by missing transfer were observed on the sheet S. Thus, when the moisture content of the sheet S is small, the permeation rate of the carrier liquid L is high. Therefore, when the carrier liquid L of the image portion of a toner image permeates the sheet S, the T/D of the image portion of the toner image increases in the secondary transfer portion N2, so that defective transfer caused by a decrease of mobility (migration rate) of toner may occur.

Therefore, in a case where the moisture content of plain paper is less than 7%, the image forming apparatus 1 in the present exemplary embodiment operates in the “carrier supply mode” illustrated in FIG. 5B. This enables causing the T/D obtained immediately before secondary transfer to become 20% to 35% in the “carrier supply mode”, while, in the “normal mode” illustrated in FIG. 5A, the T/D obtained immediately before secondary transfer is 35% to 50%. Accordingly, even in a case where the moisture content of plain paper is small, a good image in which a reduction of image density and an image loss caused by missing transfer do not occur is able to be obtained.

On the other hand, as illustrated in FIG. 7A, in the case of coated paper, in the range in which the T/D obtained immediately before secondary transfer is 35% to 50%, a good secondary transfer efficiency of 90% or more was obtained in coated paper of any moisture content. Usually, since coated paper is paper to the surface of which a coating material or resin is applied, the permeation rate of the carrier liquid L is low. Thus, the carrier liquid L of the image portion of a toner image is less likely to permeate coated paper than plain paper. In other words, the carrier liquid L of the image portion of a toner image does not easily permeate coated paper. Therefore, as illustrated in FIG. 7B, in a case where the T/D obtained immediately before secondary transfer was 40% or less and the moisture content was 7% or more, the carrier liquid L of the image portion of a toner image was excessive and a surplus carrier liquid L remained on the sheet S, so that a defective image caused by toner image deletion occurred. FIG. 7B illustrates a result obtained by examining the T/D obtained immediately before secondary transfer and the degree of occurrence of toner image deletion for every moisture content of coated paper in a case where the above-mentioned coated paper was used.

Therefore, in a case where the moisture content of coated paper is 7% or more, the image forming apparatus 1 in the present exemplary embodiment operates in the “carrier removal mode” illustrated in FIG. 5C. This enables causing the T/D obtained immediately before secondary transfer to become 45% to 60% in the “carrier removal mode”, while, in the “normal mode” illustrated in FIG. 5A, the T/D obtained immediately before secondary transfer is 35% to 50%. Accordingly, even in a case where the moisture content of coated paper is large, a good image in which a defective image caused by toner image deletion does not occur is able to be obtained.

In this way, the present exemplary embodiment optimizes the T/D obtained immediately before secondary transfer according to information about the permeation rate of the carrier liquid L for every type of sheet S. Specifically, the present exemplary embodiment controls operation modes of the carrier liquid adjustment device 20 based on information about the type of sheet S and the moisture content, thus adjusting the T/D obtained immediately before secondary transfer. In other words, in the present exemplary embodiment, the control unit 50 controls operation modes of the carrier liquid adjustment device 20 based on information about the type of sheet S to which to transfer a toner image and the output of the moisture content sensor 70, thus adjusting the liquid quantity of the carrier liquid L in the secondary transfer portion N2. Here, for more detail, the liquid quantity of the carrier liquid L in the secondary transfer portion N2 is the amount of carrier liquid L which is conveyed to the secondary transfer portion N2 per unit area for unit time.

The control unit 50 performs control as follows to increase the liquid quantity of the carrier liquid L in the secondary transfer portion N2. The control unit 50 causes a carrier liquid L stored in the carrier liquid tank 21 to be borne on the surface of the adjustment roller 24, and supplies the carrier liquid L to a liquid developer which is conveyed through a conveyance path for the liquid developer by the intermediate transfer belt 14 from the primary transfer portion N1 (the most downstream primary transfer portion N1K) to the secondary transfer portion N2. Thus, in this case, the control unit 50 causes the image forming apparatus 1 to operate in the “carrier supply mode”. In the “carrier supply mode”, the control unit 50 brings both the supply roller 22 and the adjustment roller 24 into the above-mentioned “contact state”. This causes a carrier liquid L stored in the carrier liquid tank 21 to be borne on the surface of the adjustment roller 24 via the supply roller 22, and supplies the carrier liquid L borne on the adjustment roller 24 to a liquid developer which is conveyed through the above-mentioned conveyance path.

Moreover, the control unit 50 performs control as follows to decrease the liquid quantity of the carrier liquid L in the secondary transfer portion N2. The control unit 50 does not cause a carrier liquid L stored in the carrier liquid tank 21 to be borne on the surface of the adjustment roller 24. Then, the control unit 50 removes a part of the carrier liquid L from a liquid developer which is conveyed through a conveyance path for the liquid developer by the intermediate transfer belt 14 from the primary transfer portion N1 (the most downstream primary transfer portion N1K) to the secondary transfer portion N2. Thus, in this case, the control unit 50 causes the image forming apparatus 1 to operate in the “carrier removal mode”. In the “carrier removal mode”, the control unit 50 brings the supply roller 22 into the above-mentioned “separation state” and brings the adjustment roller 24 into the above-mentioned “contact state”. This causes a carrier liquid L stored in the carrier liquid tank 21 not to be borne on the surface of the adjustment roller 24, and removes a part of the liquid developer which is conveyed through the above-mentioned conveyance path with use of the adjustment roller 24. Furthermore, in the “carrier removal mode”, the present exemplary embodiment moves the supply roller 22 away from the adjustment roller 24. However, even when the supply roller 22 is in contact with the adjustment roller 24, moving the supply roller 22 away from the carrier liquid L in the carrier liquid tank 21 enables causing the carrier liquid L not to be borne on the adjustment roller 24.

Moreover, the control unit 50 performs control as follows to neither increase nor decrease the liquid quantity of the carrier liquid L in the secondary transfer portion N2. The control unit 50 performs neither supplying nor removal of the carrier liquid L by the adjustment roller 24 with respect to a liquid developer which is conveyed through a conveyance path for the liquid developer by the intermediate transfer belt 14 from the primary transfer portion N1 (the most downstream primary transfer portion N1K) to the secondary transfer portion N2. Thus, in this case, the control unit 50 causes the image forming apparatus 1 to operate in the “normal mode”. In the “normal mode”, the control unit 50 brings the adjustment roller 24 into the above-mentioned “separation state”, thus causing the adjustment roller 24 not to act on the liquid developer which is conveyed through the above-mentioned conveyance path. Furthermore, while, in the “normal mode”, the supply roller 22 enters the above-mentioned “contact state”, in the “normal mode”, the supply roller 22 can be in contact with or away from the adjustment roller 24.

Furthermore, information about operation modes corresponding to the types of sheets S and outputs of the moisture content sensor 70 and settings of states of the carrier liquid adjustment device 20 in the respective operation modes are previously recorded on a recording device (storage unit), such as the ROM 52 or the RAM 53.

### <6. Operation Procedure>

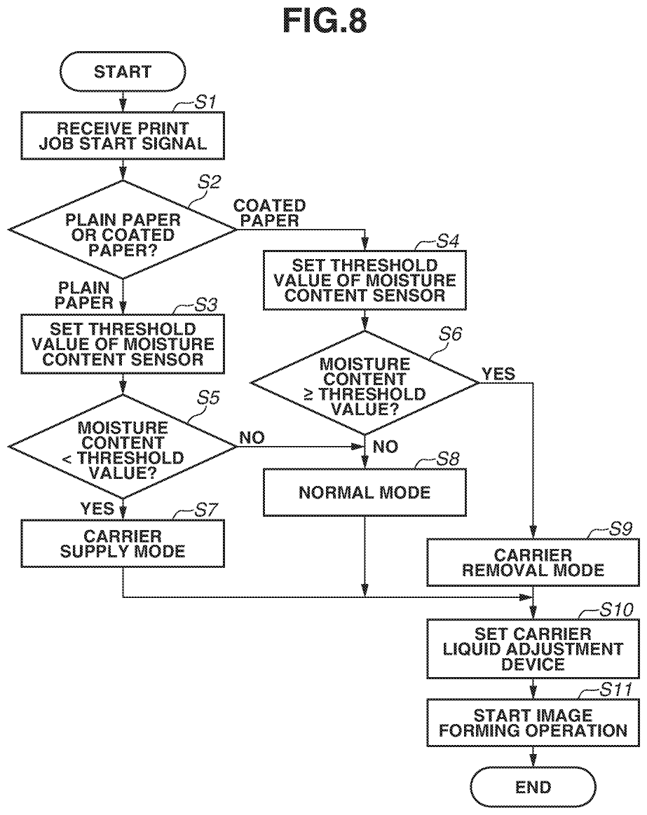

Next, a procedure of operation for setting the operation modes of the carrier liquid adjustment device 20 in the present exemplary embodiment to perform image formation is described with reference to the flowchart of FIG. 8. Control of such an operation is performed by the control unit 50. Furthermore, S1 to S11 in FIG. 8 are reference characters for specifying respective steps in processing. Here, an operation for setting one of the operation mode of the carrier liquid adjustment device 20 before starting formation of an image to be transferred to the first sheet S of a print job (a series of operations of forming an image or images on a single or a plurality of recording materials in response to one start instruction and outputting the recording material or materials) is described as an example. However, an operation of changing an operation mode of the carrier liquid adjustment device 20 can be performed during, for example, a sheet-to-sheet interval (a period corresponding to a space between a recording material and a next recording material) in the process of a print job according to a result of detection of the moisture content of sheet S for every sheet or for every predetermined number of sheets.

Upon, in step S1, receiving a print job start signal, then in step S2, the CPU 51 reads out the type of sheet S by referring to the RAM 53. In the present exemplary embodiment, the operator such as the user previously inputs information about the type of sheet S for use in image formation with use of, for example, the operation unit 11, and the input information about the type of sheet S is stored in the RAM 53. Furthermore, information about the type of sheet S is not limited to being set by the operator such as the user. For example, a sheet sensor which detects, for example, the surface roughness or glossiness of the sheet S can be provided in the image forming apparatus 1, the type of sheets S stacked in, for example, the sheet cassette 31 can be detected with use of the sheet sensor, and information about the type of sheets S can be acquired based on a result of such detection.

In step S3 or step S4, the CPU 51 determines a threshold value with respect to the output of the moisture content sensor 70 according to the read-out type of sheet S (PLAIN PAPER in step S2 or COATED PAPER in step S2). Information about the threshold value is previously stored in the ROM 52. Next, the CPU 51 measures the moisture content of the sheet S with the moisture content sensor 70, and compares the output of the moisture content sensor 70 with the threshold value, thus setting the operation mode of the carrier liquid adjustment device 20. In the present exemplary embodiment, if the sheet is plain paper (PLAIN PAPER in step S2), in a case where the moisture content of the sheet S is larger than or equal to the threshold value (in the present exemplary embodiment, 7%) (NO in step S5), then in step S8, the CPU 51 sets the “normal mode”, and, in a case where the moisture content of the sheet S is less than the threshold value (YES in step S5), then in step S7, the CPU 51 sets the “carrier supply mode”. Moreover, in the present exemplary embodiment, if the sheet is coated paper (COATED PAPER in step S2), in a case where the moisture content of the sheet S is less than the threshold value (in the present exemplary embodiment, 7%) (NO in step S6), then in step S8, the CPU 51 sets the “normal mode”, and, in a case where the moisture content of the sheet S is larger than or equal to the threshold value (YES in step S6), then in step S9, the CPU 51 sets the “carrier removal mode”. Furthermore, while, in the present exemplary embodiment, the threshold value is 7% in both cases of plain paper and coated paper based on results described with reference to FIG. 6 and FIGS. 7A and 7B, different threshold values can be determined for the respective types of sheets S based on, for example, an experiment similar to the above-mentioned experiment. Thus, the control unit 50 can change the threshold value according to the types of sheets S. For example, in the case of coated paper, the control unit 50 can set the threshold value to 6.5% based on the table illustrated in FIG. 7B, and can decrease the carrier liquid L if the moisture content of the sheet S is larger than or equal to the threshold value.

Next, in step S10, the CPU 51 sets states of the respective portions of the carrier liquid adjustment device 20 according to the set operation mode. More specifically, when setting the “normal mode”, the CPU 51 moves the adjustment roller 24 away from the intermediate transfer belt 14 as illustrated in FIG. 5A. Moreover, when setting the “carrier supply mode”, the CPU 51 brings the adjustment roller 24 into contact with the supply roller 22 and the intermediate transfer belt 14 as illustrated in FIG. 5B. Additionally, when setting the “carrier removal mode”, the CPU 51 moves the supply roller 22 away from the adjustment roller 24 while keeping the adjustment roller 24 and the intermediate transfer belt 14 in contact with each other as illustrated in FIG. 5C.

Then, after completion of setting of states of the respective portions of the carrier liquid adjustment device 20, in step S11, the CPU 51 starts an image forming operation.

In this way, in the present exemplary embodiment, the image forming apparatus 1 includes a movable image bearing member 14 on which an image is formed with use of a liquid developer including toner and a carrier liquid in an image forming position, and a transfer unit 45 configured to transfer the image from the image bearing member 14 to a recording material S in a transfer portion N2. In the present exemplary embodiment, the image bearing member is an intermediate transfer member (intermediate transfer belt) 14 to which the image is primarily transferred from a different image bearing member (photosensitive drum) 41 in a primary transfer portion N1 serving as an image forming position. Then, the transfer unit 45 secondarily transfers the image from the intermediate transfer member 14 to the recording material S in a secondary transfer portion N2 serving as the transfer portion. Moreover, in the present exemplary embodiment, the image forming apparatus 1 includes an acquisition unit 70 which acquires information about a moisture content of the recording material S. In the present exemplary embodiment, the acquisition unit is a moisture content sensor 70 which irradiates the recording material S with light and detects a reflection characteristic or transmission characteristic of the light. Moreover, in the present exemplary embodiment, the image forming apparatus 1 includes an adjustment unit (carrier liquid adjustment device) 20 which supplies a carrier liquid to the image bearing member 14 on the downstream side of the image forming position N1 and on the upstream side of the transfer portion N2 with respect to a movement direction of the image bearing member 14. Moreover, in the present exemplary embodiment, the image forming apparatus 1 includes a control unit 50 which causes the adjustment unit 20 to operate as follows. Specifically, the control unit 50 causes the adjustment unit 20 to operate in such a manner that a quantity of the carrier liquid which is conveyed to the transfer portion N2 per unit area for unit time is larger when the moisture content of the recording material S indicated by the information is a second moisture content smaller than a first moisture content than when the moisture content of the recording material S indicated by the information is the first moisture content. In the present exemplary embodiment, when the moisture content of the recording material S indicated by the information is smaller than a first threshold value, the control unit 50 causes the adjustment unit 20 to supply the carrier liquid to the image bearing member 14. On the other hand, when the moisture content of the recording material S indicated by the information is larger than or equal to the first threshold value, the control unit 50 causes the adjustment unit 20 not to supply the carrier liquid to the image bearing member 14. Moreover, the control unit 50 is able to change the first threshold value according to a type of the recording material S.

Moreover, in the present exemplary embodiment, the adjustment unit 20 is able to remove a part of the carrier liquid from the image bearing member 14 on the downstream side of the image forming position N1 and on the upstream side of the transfer portion N2 with respect to the movement direction of the image bearing member 14. Then, in the present exemplary embodiment, the control unit 50 causes the adjustment unit 20 to operate as follows. Specifically, the control unit 50 causes the adjustment unit 20 to operate in such a manner that a quantity of the carrier liquid which is conveyed to the transfer portion N2 per unit area for unit time is smaller when the moisture content of the recording material S indicated by the information is a fourth moisture content larger than a third moisture content than when the moisture content of the recording material S indicated by the information is the third moisture content. In the present exemplary embodiment, when the moisture content of the recording material S indicated by the information is smaller than a second threshold value, the control unit 50 causes the adjustment unit 20 not to remove the carrier liquid from the image bearing member 14. On the other hand, when the moisture content of the recording material S indicated by the information is larger than or equal to the second threshold value, the control unit 50 causes the adjustment unit 20 to remove the carrier liquid from the image bearing member 14. Moreover, the control unit 50 is able to change the second threshold value according to a type of the recording material S. Furthermore, the first threshold value and the second threshold value can be the same or can be different.

In particular, in the present exemplary embodiment, the adjustment unit 20 is equipped with a carrier liquid tank 21, which stores a carrier liquid. Moreover, the adjustment unit 20 is equipped with a first roller (adjustment roller) 24, which is able to come into contact with the image bearing member 14. Moreover, the adjustment unit 20 is equipped with a second roller (supply roller) 22, which is able to come into contact with a carrier liquid stored in the carrier liquid tank 21 and the first roller 24. Moreover, the adjustment unit 20 is equipped with a switching unit 29, which switches between the following first mode, second mode, and third mode. The first mode (normal mode) is a mode in which the first roller 24 is away from the image bearing member 14. Moreover, the second mode (carrier supply mode) is a mode in which the first roller 24 is in contact with the image bearing member 14 and the second roller 22 is in contact with both the first roller 24 and the carrier liquid stored in the carrier liquid tank 21. Moreover, the third mode (carrier removal mode) is a mode in which the first roller 24 is in contact with the image bearing member 14 and the second roller 22 is away from at least one of the first roller 24 and the carrier liquid stored in the carrier liquid tank 21. Then, in the present exemplary embodiment, when causing the adjustment unit 20 to perform neither supplying nor removal of the carrier liquid with respect to the image bearing member 14, the control unit 50 sets the adjustment unit 20 to the first mode. Moreover, when causing the adjustment unit 20 to supply the carrier liquid to the image bearing member 14, the control unit 50 sets the adjustment unit 20 to the second mode. Moreover, when causing the adjustment unit 20 to remove a part of the carrier liquid from the image bearing member 14, the control unit 50 sets the adjustment unit 20 to the third mode. Moreover, in the present exemplary embodiment, the adjustment unit 20 includes a power source 26, which applies a bias of the same polarity as that of toner to the first roller 24.

As described above, according to the present exemplary embodiment, the liquid quantity of the carrier liquid L in the secondary transfer portion N2 is able to be increased and decreased by the carrier liquid adjustment device 20 based on the type of a sheet S to which to transfer a toner image and the moisture content of the sheet S. With this, in a case where the excess or deficiency of a carrier liquid L may occur in the secondary transfer portion N2, the carrier liquid L is able to be adjusted to be an appropriate quantity, so that both the prevention or reduction of missing transfer and the prevention or reduction of toner deletion can be satisfied. In other words, according to the present exemplary embodiment, the quantity of a carrier liquid L which is conveyed per unit area for unit time in the secondary transfer portion N2 is able to be adjusted according to the moisture content of the sheet S, to change the T/D of the image portion of a toner image in the secondary transfer portion N2. With this, for example, even in a case where a sheet S which has been stored under a high-humidity environment or a low-humidity environment is used, the excess or deficiency of a carrier liquid S in the secondary transfer portion N2 can be prevented or reduced according to the degree of ease of permeation of the carrier liquid S into the sheet S in the secondary transfer portion N2.

While the present invention has been described based on a specific exemplary embodiment, the present invention is not limited to the above-described exemplary embodiment.

While, in the above-described exemplary embodiment, an example in which operation modes of the carrier liquid adjustment device 20 are switched with respect to two types of sheets S, plain paper and coated paper, has been described, the present invention is not limited to this. For example, since a carrier liquid L of the image portion of a toner image does not permeate resin media typified by an OHT sheet, an operation mode for resin media can be provided. Thus, in the case of the operation mode for resin media, the carrier liquid adjustment device 20 is set to the “carrier removal mode” in the above-described exemplary embodiment. Moreover, operation modes can be changed according to the thickness or surface roughness of the sheet S. Optimum threshold values of the moisture content to the respective operation modes can be separately provided. Additionally, a plurality of threshold values can be set with respect to the same sheet S.

Moreover, while, in the above-described exemplary embodiment, the carrier liquid adjustment device 20 is configured to be able to perform increasing and decreasing of the carrier liquid L, the present invention is not limited to this. Depending on the viscosity of a liquid developer for use or the type of a sheet S for use, the carrier liquid adjustment device 20 can be configured to perform only one of increasing and decreasing of the carrier liquid L. For example, in the case of a system in which, out of the excess and deficiency of a carrier liquid L in the secondary transfer portion N2, there is concern about only the deficiency of a carrier liquid L substantially due to the permeation of the carrier liquid L into the sheet S, the carrier liquid adjustment device 20 only needs to be configured to be able to increase the quantity of the carrier liquid L. In this case, for example, the carrier liquid adjustment device 20 can be configured to be able to switch the operation mode between the “normal mode” (FIG. 5A) and the “carrier supply mode” (FIG. 5B). Moreover, for example, in the case of a system in which, out of the excess and deficiency of a carrier liquid L in the secondary transfer portion N2, there is concern about only the excess of a carrier liquid L substantially due to the unlikeliness of permeation of the carrier liquid L into the sheet S, the carrier liquid adjustment device 20 only needs to be configured to be able to decrease the quantity of the carrier liquid L. In this case, for example, the carrier liquid adjustment device 20 can be configured to be able to switch the operation mode between the “normal mode” (FIG. 5A) and the “carrier removal mode” (FIG. 5C).

Moreover, while, in the above-described exemplary embodiment, the carrier liquid adjustment device 20 is configured to switch whether to increase or decrease the carrier liquid L, the present invention is not limited to this. The carrier liquid adjustment device 20 can be configured to change the quantity by which to increase or decrease the carrier liquid L, according to the moisture content of the sheet S. The method for enabling adjusting the increased or decreased quantity of the carrier liquid L includes, for example, the following methods. One method includes changing the relative speed of, for example, the supply roller 22, the adjustment roller 24, or the adjustment portion counter roller 19 to the intermediate transfer belt 14. Moreover, another method includes changing a contact pressure between the supply roller 22 and the adjustment roller 24 or between the adjustment roller 24 and the adjustment portion counter roller 19. Moreover, yet another method includes changing a pressure of contact of the supply roller regulating blade 23 with the supply roller 22 or a pressure of contact of the adjustment roller regulating blade 25 with the adjustment roller 24. For example, as the moisture content of the sheet S is smaller according to the type of the sheet S, the quantity by which to increase the carrier liquid L can be made larger. Moreover, as the moisture content of the sheet S is larger according to the type of the sheet S, the quantity by which to decrease the carrier liquid L can be made larger.

Moreover, in the image forming apparatus 1 in the above-described exemplary embodiment, the development device 60 includes the development electrode 63 and the squeeze roller 64. Therefore, decreasing the quantity of the carrier liquid L, in other words, concentrating toner in the liquid developer, is able to be performed on the upstream side of the development portion 41d. Therefore, to increase the T/D obtained immediately before secondary transfer, settings of the development electrode 63 and the squeeze roller 64, in addition to the carrier liquid adjustment device 20, can be adjusted to increase the T/D.

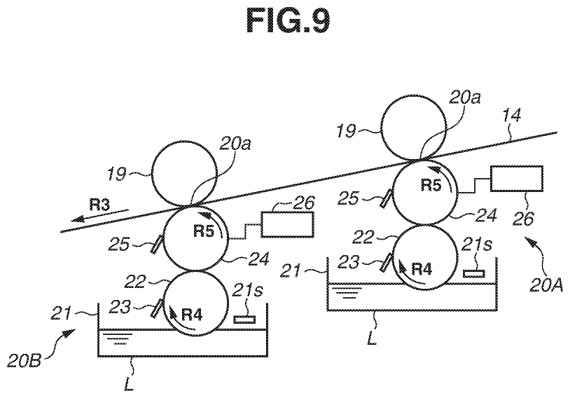

Moreover, while, in the above-described exemplary embodiment, a case where only one carrier liquid adjustment device 20 is provided has been described, the present invention is not limited to this. For example, as illustrated in FIG. 9, two or more carrier liquid adjustment devices 20 (20A and 20B) can be provided. In this case, as compared with a case where only one carrier liquid adjustment device 20 is provided, a larger quantity of the carrier liquid L is able to be used to increase and decrease the carrier liquid L, so that, for example, toner deletion which would occur in a case where a low-viscosity liquid developer is used can be effectively prevented or reduced. In a case where a plurality of carrier liquid adjustment devices 20 is provided, an adjustment unit is constituted by the plurality of carrier liquid adjustment devices 20. Moreover, in a case where a plurality of carrier liquid adjustment devices 20 is provided, the respective functions of increasing and decreasing the quantity of the carrier liquid L can be allocated in a sharing manner between the plurality of carrier liquid adjustment devices 20. For example, in a case where two carrier liquid adjustment devices 20A and 20B are provided as illustrated in FIG. 9, one carrier liquid adjustment device 20A can take the share of only increasing the quantity of the carrier liquid L, and the other carrier liquid adjustment device 20B can take the share of only decreasing the quantity of the carrier liquid L. The carrier liquid adjustment device 20B, which is caused to take the share of only decreasing the quantity of the carrier liquid L, does not need to be provided with a supply roller 22. Furthermore, in FIG. 9, elements having the same or corresponding functions or configurations as those in the above-described exemplary embodiment are assigned the respective same reference characters.

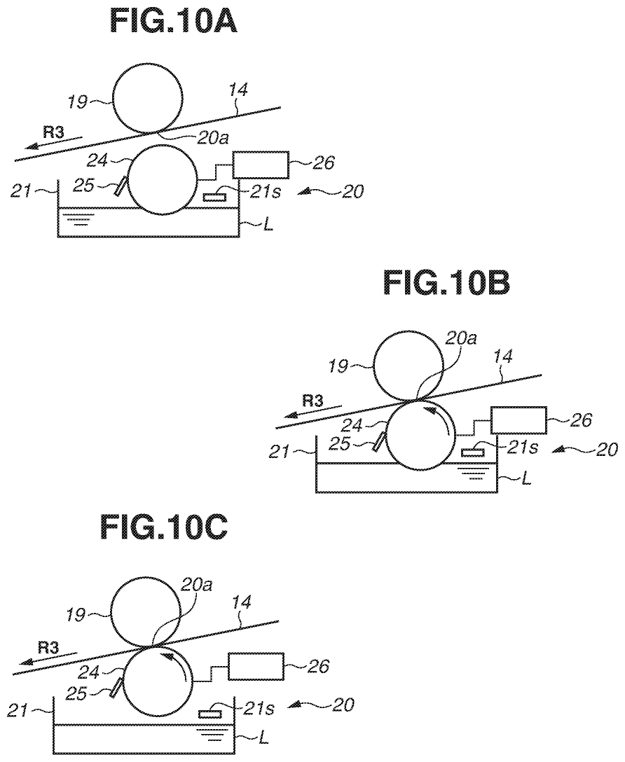

Moreover, while, in the above-described exemplary embodiment, a case where the carrier liquid adjustment device 20 includes the supply roller 22 and the adjustment roller 24 has been described, the present invention is not limited to this. For example, without the use of the supply roller 22, the carrier liquid L can be directly supplied to the adjustment roller 24, and the quantity of the carrier liquid L borne on the adjustment roller 24 can be regulated (adjusted) by the adjustment roller regulating blade 25. In this instance, in a case where the excess or deficiency of a carrier liquid L may occur in the secondary transfer portion N2, the carrier liquid L is also able to be adjusted to be an appropriate quantity, so that both the prevention or reduction of missing transfer and the prevention or reduction of toner deletion can be satisfied. For example, as illustrated in FIGS. 10A, 10B, and 10C, the adjustment roller 24 is configured to be able to come into contact with and move away from the intermediate transfer belt 14, and the adjustment roller 24 is also configured to be able to come into contact with and move away from the carrier liquid L in the carrier liquid tank 21. In this case, similar to the above-described exemplary embodiment, the operation modes of the carrier liquid adjustment device 20 are able to be switched between the “normal mode” (FIG. 10A), the “carrier supply mode” (FIG. 10B), and the “carrier removal mode” (FIG. 10C). Furthermore, in FIGS. 10A to 10C, elements having the same or corresponding functions or configurations as those in the above-described exemplary embodiment are assigned the respective same reference characters.

Moreover, while, in the above-described exemplary embodiment, the moisture content sensor 70 is located in such a way as to detect the moisture content of the sheet S which is caused to be at a stop by the registration roller 33, the position at which to locate the moisture content sensor 70 is not particularly limited as long as it is on a conveyance path for the sheet S. For example, the moisture content sensor 70 can be located inside the sheet cassette 31 and can be configured to measure the moisture content of the sheet S stored in the sheet cassette 31. However, in a case where the moisture content sensor 70 is located on the downstream side of the secondary transfer portion N2 and on the upstream side of the fixing device 46 or is located on the downstream side of the fixing device 46 with respect to the conveyance direction of the sheet S, it is desirable to take the following issue into consideration. Specifically, in this case, depending on the types of moisture content sensors, the accuracy of measurement may decrease under the influence of toner and a carrier liquid L which are transferred to the surface of the sheet S in the secondary transfer portion N2. Therefore, it is desirable that the moisture content sensor 70 be located on the upstream side of the secondary transfer portion N2 with respect to the conveyance direction of the sheet S.

Moreover, an image forming apparatus 1 which is able to form images on both sides of the sheet S can be configured as follows. Specifically, the moisture content sensor 70 is located on a conveyance path through which the sheet S passes during image formation for both the obverse surface and the reverse surface of the sheet S and on the upstream side of the secondary transfer portion N2. In this case, since, during image formation for the reverse surface of the sheet S, the moisture content of the sheet S having once passed through the fixing device 46 is also able to be measured, a higher-accuracy measurement of moisture content can be performed. In other words, during double-sided image formation, the operation mode of the carrier liquid adjustment device 20 is able to be set according to the moisture content which has been detected before image formation for the first surface, and the operation mode of the carrier liquid adjustment device 20 is also able to be set according to the moisture content which has been detected before image formation for the second surface.

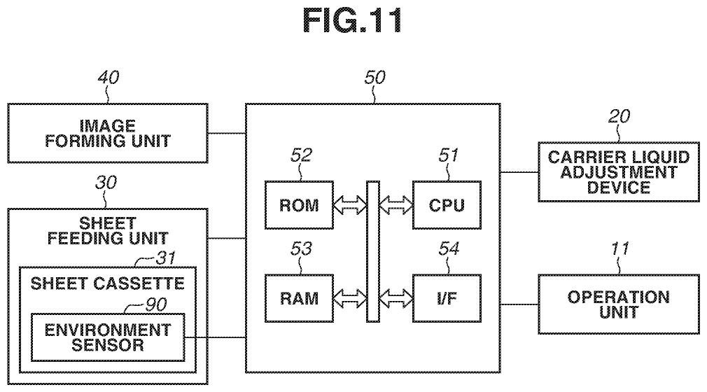

Moreover, the method for acquiring information about the moisture content of the sheet S is not limited to directly detecting the moisture content of the sheet S with use of the moisture content sensor 70. For example, as illustrated in FIG. 11, an environment sensor 90, which measures the temperature and humidity of an atmosphere inside the sheet cassette 31, can be provided, and the control unit 50 can be configured to estimate the moisture content of the sheet S based on a result of detection by the environment sensor 90. In this case, for example, information indicating a relationship between the absolute moisture content of the environment that is based on a result of detection by the environment sensor 90 and the moisture content of the sheet S for every type of the sheet S is previously stored in the ROM 52. Then, the control unit 50 is able to acquire information about the moisture content of the sheet S based on the absolute moisture content obtained from a result of detection by the environment sensor 90 and the above-mentioned information indicating the relationship. The environment sensor 90 is an example of an environment detection unit which detects at least one of the temperature and humidity of at least one of the inside and outside of the image forming apparatus 1, and is able to be used as a unit which acquires information about the moisture content of the sheet S. Thus, the unit which acquires information about the recording material S can be the environment sensor 90, which detects the environment of the container portion for the recording material S.

Moreover, while, in the above-described exemplary embodiment, the adjustment portion counter roller 19 is used as an adjustment portion counter member, the adjustment portion counter member is not limited to a rotatable roller-shaped member. The adjustment portion counter member can be any form of member, such as a nonrotatable roller-shaped member, a pad-shaped member, or a brush-shaped member.

Moreover, the present invention can also be applied to, for example, a monochrome image forming apparatus, which includes only one photosensitive member serving as an image bearing member. In this case, an image formed on the photosensitive member with a liquid developer may be directly transferred to a recording material. In that case, an image forming position at which to form an image with a liquid developer on an image bearing member serves as a development portion at which to develop an electrostatic image with a development device.

According to the present invention, the excess and deficiency of a carrier liquid in a transfer portion can be prevented or reduced according to the moisture content of a recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-123762, filed Jun. 28, 2018, which is hereby incorporated by reference herein in its entirety.

What is claimed is:

1. An image forming apparatus comprising:
a movable image bearing member on which an image is formed with use of a liquid developer including toner and a carrier liquid in an image forming position;
a transfer device configured to transfer the image from the image bearing member to a recording material in a transfer position;
an acquisition unit configured to acquire information about a moisture content of the recording material;
a supply device configured to be able to supply a carrier liquid to the image bearing member on a downstream side of the image forming position and on an upstream side of the transfer position with respect to a movement direction of the image bearing member; and
a control unit configured to cause the supply device to operate in such a manner that a quantity of the carrier liquid which is conveyed to the transfer position per unit area for unit time is a first amount in a case where the moisture content of the recording material indicated by the information acquired by the acquisition unit is a first moisture content, and the quantity of the carrier liquid which is conveyed to the transfer position per unit area for unit time is a second amount larger than the first amount in a case where the moisture content of the recording material indicated by the information acquired by the acquisition unit is a second moisture content which is smaller than the first moisture content.

2. The image forming apparatus according to claim 1, wherein, in a case where the moisture content of the recording material indicated by the information is smaller than a first threshold value, the control unit causes the supply device to operate in such a manner that the carrier liquid is supplied to the image bearing member by the supply device, and, in a case where the moisture content of the recording material indicated by the information is larger than or equal to the first threshold value, the control unit causes the supply device to operate in such a manner that the carrier liquid is not supplied to the image bearing member by the supply device.

3. The image forming apparatus according to claim 2, wherein the control unit is able to change the first threshold value according to a type of the recording material.

4. The image forming apparatus according to claim 1,
wherein the supply unit is able to remove a part of the carrier liquid from the image bearing member on the downstream side of the image forming position and on the upstream position of the transfer position with respect to the movement direction of the image bearing member, and
wherein the control unit causes the supply device to remove a part of the carrier liquid from the image bearing member in a case where the moisture content of the recording material indicated by the information is a second threshold value larger than the first threshold value.

5. The image forming apparatus according to claim 4, wherein the control unit is able to change the second threshold value according to a type of the recording material.

6. The image forming apparatus according to claim 4,
wherein the supply device includes:
a carrier liquid tank configured to contain a carrier liquid;
a first roller configured to be able to come into contact with the image bearing member;
a second roller configured to be able to come into contact with the carrier liquid contained in the carrier liquid tank and the second roller; and
a switching mechanism configured to switch between a first mode in which the first roller is away from the image bearing member, a second mode in which the first roller is in contact with the image bearing member and the second roller is in contact with both the first roller and the carrier liquid contained in the carrier liquid tank, and a third mode in which the first roller is in contact with the image bearing member and the second roller is away from at least one of the first roller and the carrier liquid contained in the carrier liquid tank, and
wherein the control unit sets the supply device to the first mode in a case where neither supplying nor removal of the carrier liquid with respect to the image bearing member by the supply device is performed, sets the supply device to the second mode in a case where the carrier liquid is supplied to the image bearing member by the supply device, and sets the supply device to the third mode in a case where a part of the carrier liquid is removed from the image bearing member by the supply device.

7. The image forming apparatus according to claim 6, wherein the supply device includes a power source configured to apply a bias with a polarity identical to that of toner to the first roller.

8. An image forming apparatus comprising:
a movable image bearing member on which an image is formed with use of a liquid developer including toner and a carrier liquid in an image forming position;
a transfer device configured to transfer the image from the image bearing member to a recording material in a transfer position;
an acquisition unit configured to acquire information about a moisture content of the recording material;
a removal device configured to be able to remove a part of the carrier liquid from the image bearing member on a downstream side of the image forming position and on an upstream side of the transfer position with respect to a movement direction of the image bearing member; and
a control unit configured to cause the removal device to operate in such a manner that a quantity of the carrier liquid which is conveyed to the transfer position per unit area for unit time is a first amount in a case where the moisture content of the recording material indicated by the information is a first moisture content, and the quantity of the carrier liquid which is conveyed to the transfer position per unit area for unit time is a second amount smaller than the first amount in a case where the moisture content of the recording material indicated by the information is a second moisture amount larger than the first moisture content.

9. The image forming apparatus according to claim 8, wherein, in a case where the moisture content of the recording material indicated by the information is smaller than a threshold value, the control unit causes the removal device to operate in such a manner that removal of the carrier liquid from the image bearing member by the removal device is not performed, and, in a case where the moisture content of the recording material indicated by the information is larger than or equal to the threshold value, the control unit causes the removal device to operate in such a manner that a part of the carrier liquid is removed from the image bearing member by the removal device.

10. The image forming apparatus according to claim 9, wherein the control unit is able to change the threshold value according to a type of the recording material.

11. The image forming apparatus according to claim 1, wherein the acquisition unit is a moisture content sensor configured to irradiate the recording material with light and detect a reflection characteristic or transmission characteristic of the light.

12. The image forming apparatus according to claim 1, wherein the acquisition unit is an environment sensor configured to detect an environment of a container portion for the recording material.

13. The image forming apparatus according to claim 1, wherein the image bearing member is an intermediate transfer member to which the image is primarily transferred from a different image bearing member at a primary transfer portion serving as the image forming position, and the transfer device causes the image to be secondarily transferred from the intermediate transfer member to the recording material at a secondary transfer position serving as the transfer position.

14. The image forming apparatus according to claim 1, wherein the image bearing member is a photosensitive member on which an electrostatic image is formed, and the image is formed by the electrostatic image being developed with the liquid developer at a development portion serving as the image forming position.
